(19) United States
(12) Patent Application Publication
(10) Pub. No.: US 2024/0217073 A1
(43) Pub. Date: Jul. 4, 2024

(54) Dual Direction Ratcheting Device

(71) Applicant: Nigel Buchanan, New Gilston (GB)

(72) Inventor: Nigel Buchanan, New Gilston (GB)

(21) Appl. No.: 17/604,384

(22) PCT Filed: Apr. 15, 2020
(86) PCT No.: PCT/EP2020/060635

§ 371 Date: Nov. 24, 2021

(30) Foreign Application Priority Data
Apr. 15, 2019 (GB) 1905295.0

(51) Int. Cl. B25B 13/46

(52) U.S. Cl. CPC B25B 13/466; B25B 13/467

(57) ABSTRACT

A no switch, dual direction, ratcheting screwdriver (1), comprising a handle (60) incorporating a housing (50) encapsulated ratchet mechanism (11), further comprising a drive gear (30), attached to the housing (50) within the handle (60) and the driven gear (31) attached to the screwdriver shaft (20), the annular crown wheel type drive and driven gears (30, 31) having gear-engaging teeth (32) around their periphery. At rest a resilient member (40) prevents the drive and driven gears (30, 31) from engagement with each other. The operator engaging the screwdriver operating profile (26) into the corresponding screw head (81) naturally pushing the screwdriver handle (60) forward (FF), robustly engaging the fastener (80), further compressing the resilient member (40), robustly locking the drive and driven gears (30, 31) as one, the screw (80) being operated as required. As the operator relaxes the forward force (FF) during the reposition procedure (R) the drive and driven gears (30, 31) disengage from one another urged by the resilient portion (40) allowing a smooth minimum torque reverse procedure (R).

### FIELD OF THE INVENTION

The invention relates to a reversible, or dual direction, ratcheting device or torque driver and particularly, but not exclusively, toto ratcheting screwdrivers and is disclosed in that context.

### BACKGROUND TO THE INVENTION

A variety of dual direction ratcheting mechanisms are known in the art, particularly those used in ratcheting screwdrivers with interchangeable drive bits. Conventional screwdriver ratchet mechanisms may have pivotal drive pawls which are urged into driving engagement with a shaft-mounted driven gear by one or more springs. The drive pawls may be slidably and pivotally movable into and out of engagement with the driven gear. U.S. Pat. No. 6,679,363 (Marchant) discloses a typical example of this type of mechanism.

However, as the ratchet mechanism is normally situated within the screwdriver operating handle, it has to be small. This results in the true engagement between a small number of pawl teeth and the driven gear teeth being very limited indeed. The resultant low torque capability renders this type of mechanism inadequate for use where high torque transmission is required.

U.S. Pat. No. 9,511,484 (Marchant et al) overcomes the problem of inadequate drive pawl to shaft gear torque transmission capability in a ratcheting screwdriver by the use of a series of three annular bevelled gears comprising a driven gear sandwiched between two drive gears. The drive gears are driven into engagement with the driven gear by respective biasing springs and each have tabs that are received in axially extending slots provided in a directional cap, which functions as a direction changing switch. The drive and drive gears are housed within a ball-holding support member. Respective actuation balls are received in apertures provided in the ball-holding support member and engage the directional cap and the tabs on the drive gears. In a first position of the directional cap, both drive gears engage the driven gear under the influence of their respective biasing springs. The directional cap can be rotated to second and third positions. In the second position, the balls engaging a first of the drive gears are driven towards the output shaft of the screwdriver causing them to push against the tabs of the first drive gear to drive the first drive gear back against its biasing spring and out of engagement with the driven gear. This provides a ratcheting, or reverse, action that allows a torque to be applied to a fastener in a forward direction and a reverse repositioning rotation of the handle in the opposite direction. In analogous fashion, moving the rotational cap to the third position, leaves the first drive gear in engagement with the driven gear under the action of its biasing spring while the second of the drive gears is driven out of engagement with the driven gear by respective balls engaging the tabs of the second drive gear. This allows a torque to be applied to the fastener in the opposite direction to the forward direction and a reverse repositioning rotation of the handle in the opposite direction. However, this mechanism has a minimum of 25-30 parts and as a result is extremely complex and expensive both to manufacture. The result is a tool with a very niche restricted marketplace. Furthermore, the use of bevelled gear profiles mean that the gears have an inbuilt an unwanted play as the interacting gears ride up the bevelled faces of the opposing drive to driven gears into and out of engagement.

All prior art dual direction ratcheting screwdrivers require direction change switches. The direction change switch can be a rotary or slide type of varying cost and complexity. All but the most expensive products are unserviceable, moisture and detritus rendering the ratcheting mechanism inoperative. In use the switch orientation can require a two-handed operation and unless the operator is using that particular type of screwdriver on a regular basis, the switch needs either a visual or rotational positional test check before use.

All prior art ratcheting screwdrivers require a significant reverse or reposition torque resistances as their sprung pawls or gears, which are resiliently driven against each other, move against one another in the reverse or reposition action. If the fastener being driven provides relatively low resistance to turning, typically in the early stages of a tightening operation, it will simply rotate backwards or forwards so that the ratcheting mechanism fails to function. Then, the operator will usually have to lightly grip the screwdriver shaft, requiring the use of two hands in order to allow the ratcheting mechanism to be utilised.

In summary, there are problems and shortcomings in ratcheting screwdrivers of the prior art for use when reasonable or high torque is required whilst cost restraints are maintained.

### SUMMARY OF THE INVENTION

It is a general object of the invention to provide an uncomplicated cost-effective torque driver or ratcheting screwdriver that avoids at least one of the disadvantages of prior art ratcheting screwdrivers while affording additional structural and operational advantages, or at least to provide an alternative to existing products. Although the mechanism used is not strictly a true ratchet, in use it may be categorised as such.

Embodiment of the invention provide a bi-directional reversing torque driver as specified in claim 1.

Embodiments of the invention also provide a no switch, dual direction, ratcheting screwdriver, comprising a handle portion with a proximal end and a distil end, the proximal end incorporating the housing encapsulated ratchet mechanism is connected to the elongate shaft of the screwdriver in order to transmit motion and torque to the elongate shaft as required, in the direction required. The device includes two annular gears, the drive gear attached to the handle portion and the driven gear attached to the screwdriver shaft, each having gear-engaging teeth around their periphery. The device also includes at least one resilient member which prevents the drive and driven teeth from engagement with each other when at rest or when insufficient compression of the resilient portion is applied. The operator as he or she engages the engagement or operating profile of the screwdriver tip into the corresponding screw or fastener head to be operated, naturally pushes the screwdriver handle forward towards the engaged fastener, hereinafter termed the forward force, in order to ensure positive engagement of the screwdriver tip within the corresponding screw head profile. This robust forward force further compresses the resilient member and engages the drive gear teeth into the corresponding driven gear teeth, robustly locking the drive and driven gears as one, the screw being operated as required until the screwdriver requires to be repositioned or reversed ready for the next drive operation. As the operator intuitively relaxes the forward force during the reposition procedure the drive and driven gears usefully disengage from one another urged by the incumbent resilient portion allowing a smooth minimum torque reposition or reverse procedure.

An optional feature of the ratcheting screwdriver, when in use and the forward force is applied, is the automatic engagement between the drive handle and the driven screwdriver shaft whereas the chosen drive direction and actual drive is accomplished without the need or operation of a direction biasing switch.

An optional feature of the ratcheting screwdriver is that the reverse or reposition action is accomplished with a very minimum of torque as there is no interaction between any sprung pawl or gear drive teeth and the shaft driven teeth as in the prior art.

An optional feature of the ratcheting screwdriver is the provision of a resilient portion forcing the drive and driven teeth of the ratchet apart whilst at rest or when utilised in the reverse or reposition action, whereas all the prior art teaches the direct opposite by using the resilient portion or portions to force the drive and driven teeth towards one another at all times.

An optional feature of the ratcheting screwdriver is the provision of castellated drive and driven gear teeth that are radially located on all gears, allowing all of the drive and driven teeth to be engaged at one time thereby significantly increasing the level of drive torque that can be applied by the operated screwdriver to the driven fastener whilst minimising the amount of unwanted play during the engagement between the drive and driven gears.

An optional feature of the ratcheting screwdriver, when in use, is a ratchet like locking design wherein the annular drive and driven gear teeth include correspondingly upright flat engagement faces in order to provide superior engagement between the drive and driven gear teeth with the minimum of generated thrust force and therefore the reduction of the forward force requirement.

An optional feature of the ratcheting screwdriver is the provision of a castellated drive and driven gear teeth that are radially located on both the drive and driven gears, whereas the opposing tips of the drive and driven teeth are peaked, ensuring effortless and efficient engagement between the drive and driven teeth as the forward force is applied.

An optional feature of the ratcheting screwdriver is the provision of a sealed outer housing which encases the ratchet mechanism and further robustly connects the ratcheting mechanism and shaft portion to the handle portion. The housing can be secured to or within the handle by known mechanical means or glued in position but the normal method is to over-mould the outer housing within the ubiquitous plastic handle. In order to minimise costs the outer housing can be manufactured as a low cost die casting, although an infrequent use “do it yourself” example could use die cast drive gear teeth, in the preferred high quality example the drive gear are made from MIM (metal injection moulding) or HPM (high pressure mouldings) which can produce high precision, strong, intricate metal parts very cost effectively, providing the weight is low. The actual metal moulded drive gear can be further mechanically robustly attached within the inner housing as required by rivets formed within the metal mouldings to form a low-cost housing incorporating a wear resistant high torque drive gear.

An optional feature of the ratcheting screwdriver is the driven gear has a central engagement profile preferably incorporating at least two flats which mechanically engage the similar internal profile of the screwdriver shaft. One possible type of fixture of the driven gear to the shaft is shown as an external circlip. This type of fixture usefully allows the simple inexpensive shaft type whether long, short, having interchangeable drive bits or incorporating only one single screw operating profile to be fitted to the handle and ratcheting mechanism at final assembly allowing the greatest flexibility in production for customer requirements.

Another optional feature of the ratcheting screwdriver is the provision of an axle bore within the housing for the lubricated close interaction with the handle end of the screwdriver shaft to provide a method of ensuring minimum flexing between the shaft and the handle portion. The flats within the shaft further preventing any possible piston like pressure action, as the forward force is applied.

Another optional feature of the ratcheting screwdriver is the provision of a seal groove within the periphery of the driven gear, preferably an O-ring type housing seal fitted within said groove acts between the driven gear and the housing inner profile to prevent the ingress of detritus and or moisture into the housing encapsulated ratchet mechanism during storage or use.

Another optional feature of the ratcheting screwdriver is the provision of a method of construction which enables the ratchet mechanism to be serviced or repaired by the operator without specialist tools. The screwdriver shaft and its attached driven gear can be usefully disengaged from the housing by the removal of one internal circlip from its retention groove within the internal lip of the housing although any alternate sealed for life type closure could be employed.

The ratcheting screwdriver is not limited to use with screws and may be used to apply a torque to other types of fastener.

### BRIEF DESCRIPTION OF THE DRAWINGS

Some embodiments of the invention, which are given by way of example only, will now be described with reference to the drawings in which:

FIG. 1 is a perspective view of a no-switch ratcheting screwdriver with the proximal end of the handle portion shown in section for display purposes;

FIG. 2 is a perspective view of the no-switch ratcheting screwdriver in use;

FIG. 3 is a partially sectioned side view of the no-switch ratcheting screwdriver shown in an at rest or reposition mode;

FIG. 4 is a partially sectioned side view of the no-switch ratcheting screwdriver shown in a torque applying mode;

FIG. 5 is an exploded perspective view of the no-switch ratcheting screwdriver;

FIG. 6 is a further exploded perspective view of the no-switch ratcheting screwdriver; and

FIG. 7 is a perspective view of the no-switch ratcheting screwdriver with an outer handle part removed.

### REFERENCE TO THE DRAWINGS

The following is a listing of the various components used in the best mode preferred embodiment and alternative embodiments. For the ready reference of the reader the reference numerals have been arranged in ascending numerical order.

1/No-Switch Ratcheting Screwdriver
11/Housing Encapsulated Ratchet Mechanism
20/Elongate Output Shaft
21/Shaft Inboard End
22/Shaft Bit Holder Recess
23/Shaft Circlip Groove
24/Driven Gear Retention Portion
25/Gear Engagement Flats
26/Screwdriver Bit
27/Interchangeable Screwdriver Bit
30/Drive Gear
31/Driven Gear
32/Gear Teeth
33/Teeth Engagement Faces
34/Tooth Tips
35/Shaft Engagement Aperture
36/Rivets
37/Driven Gear Shaft Engagement Flats
38/Driven Gear Seal Groove
39/Gear Teeth Engagement Faces
40/Resilient Portion
50/Housing
51/Housing Inner Profile
52/Housing Outer Profile
53/Housing Gripping Ribs
54/Housing Spring Bore
55/Housing/Shaft Axle Bore
56/Circlip Groove
57/Housing Drive Gear, Rivet Holes
58/Housing Internal Lip
60/Handle Portion
61/Handle Gripping Profile
62/Handle Distal End
63/Handle Proximal End
64/Handle Housing Recess
70/Internal Circlip
71/External Circlip
72/Housing Seal
73/Washer
80/Fastener
81/Fastener Head
82/Recess
90/Workpiece
FF/Forward Force
DT Drive Torque
CD/Clockwise Direction
ACD/Anti -Clockwise Direction

### DETAILED DESCRIPTION

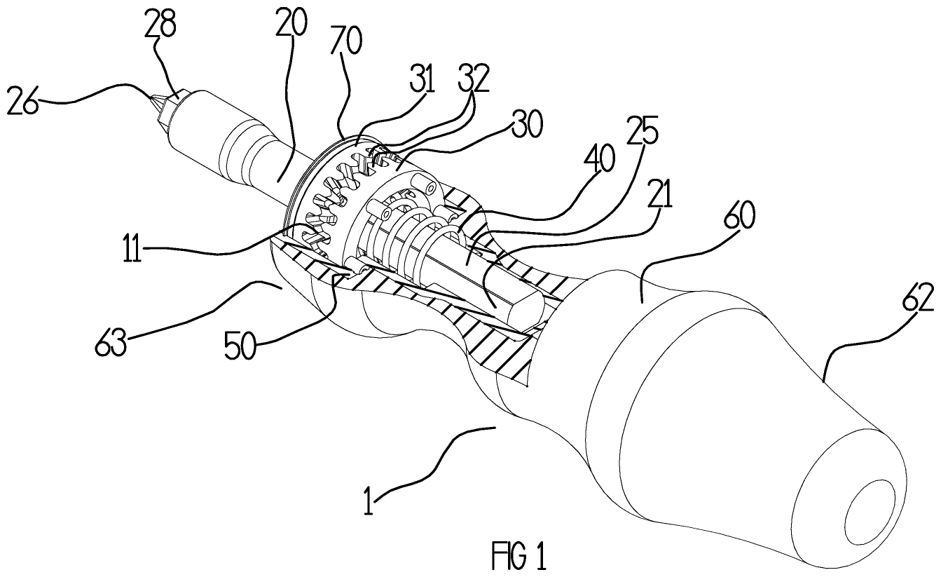

FIGS. 1 to 7 illustrate a bidirectional reversing torque driver, which may take the form of a no switch, dual direction, ratcheting screwdriver 1. The screwdriver 1 comprises a handle portion 60 with a proximal end 63 and a distal end 62. The proximal end 63 is configured to receive an encapsulated ratchet mechanism 11 connected to an elongate output shaft 20. The ratchet mechanism 1 includes two annular gears comprising a drive gear 30 attached to the handle portion 60 and a driven gear 31 attached to the output shaft 20. Each gear 30, 31 has a set of teeth 32. The ratchet mechanism 11 further includes at least one resilient member 40, which biases the gears 30, 31 out of engagement. The at least one resilient member 11 may comprise a compression spring that has to be compressed to allow the gears 30, 31 to engage.

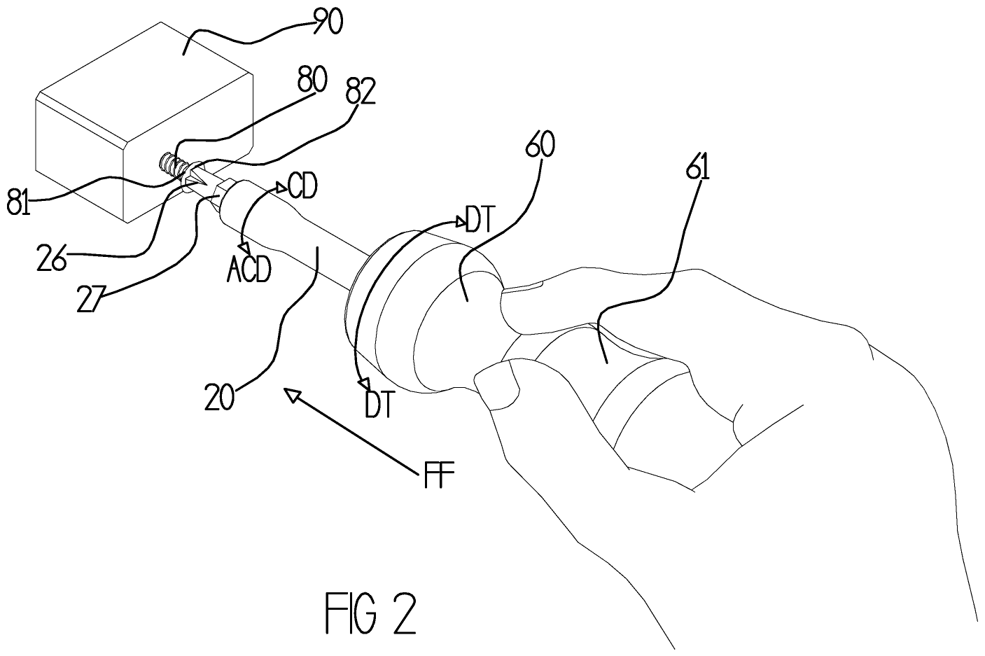

Referring to FIG. 2, when an operator wishes to apply a torque to a fastener 80, a screwdriver bit 26 disposed at the free end of the output shaft 26 is inserted into a recess 82 in the fastener head 81. As the screwdriver bit 26 is inserted into recess 82, the operator naturally pushes the handle portion 60 forward towards the fastener 80, applying what is hereinafter termed the forward force FF, in order to ensure positive engagement of the screwdriver bit 26 within the recess 82. This forward force FF compresses the resilient member 40 allowing the teeth 32 of the gears 30, 31 to engage thereby locking the drive and driven gears 30, 31. The handle portion 60 can then be turned in either direction to apply a drive torque DT to the fastener 80 until the screwdriver 1 needs to be repositioned, or reversed, ready for the next drive torque sequence. As the operator will intuitively relax the forward force FF during the repositioning procedure, the drive and driven gears 30, 31 are automatically disengaged by the biasing force applied by the resilient member 40, so allowing a smooth minimum torque repositioning or reverse procedure that does not require the fastener 80 engagement with the workpiece 90 to provide a resistance force in order to function.

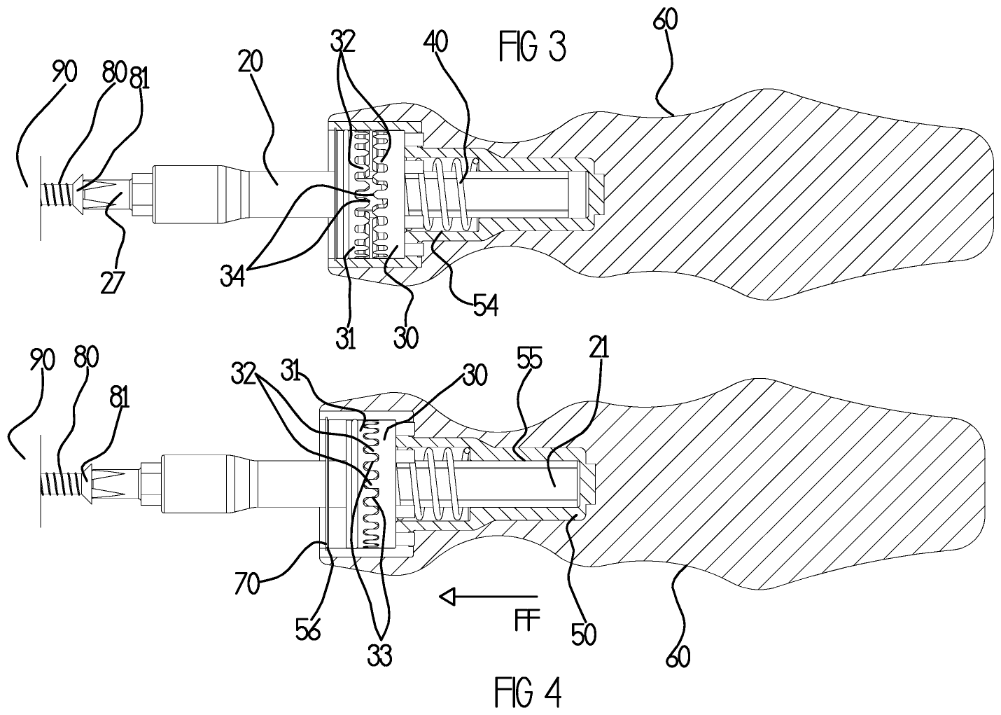

FIGS. 1 and 3 show the resilient member 40 forcing, or biasing, the drive and driven gears 30, 31 out of engagement when the screwdriver 1 is at rest or during a repositioning action. As best seen in FIGS. 3, 5 and 6, the respective sets of teeth 32 on the drive and driven gears 30, 31 comprise castellations provided on opposed major faces of the gears 30, 31. The respective sets of teeth 32 project, or extend, towards one another. The respective teeth 32 of the drive and driven gears 30, 31 may be disposed in equi-spaced relationship around the periphery of the respective opposed major faces of the gears 30, 31. The arrangement of the respective sets of teeth 32 allows all the drive and driven gear 30, 31 teeth 32 to be at least substantially engaged when an adequate forward force FF is applied to the handle portion 60, thereby significantly increasing the level of drive torque that can be applied by the screwdriver 1 to a fastener, such as the fastener 80 shown in FIG. 2, whilst minimising the amount of unwanted play during the engagement between the drive and driven gears 30, 31. The teeth 32 may have respective pairs of upright flat engagement faces, or flanks, 33 in order to provide superior engagement with a very minimum forward force FF required to ensure a sustained engagement between the said drive and driven gears 30, 31 and a minimum resistance to separation of the gears 30, 31 by the resilient member 40 when the forward force FF is released. The engagement faces 33 may extend at least substantially parallel to the output shaft 20. The tips 34 of the teeth 32 may be peaked, or bevelled, in order to ensure effortless and efficient engagement as the forward force FF is applied. Thus, as shown in the illustrated example, the tips may be defined by respective surfaces that are extend from the engagement faces 33 are inclined with respect to the engagement surfaces towards one another.

FIGS. 1, 5 and 7 illustrate an embodiment in which the ratchet mechanism 11 is enclosed within a housing 50 by which the ratchet mechanism 11 and output shaft 20 are connected to the handle portion 60. The ratcheting mechanism is preferably sealed within the housing 50. The housing 50 may be secured to, or within, the handle portion 60 by known mechanical means or by an adhesive. Another connection method is to over-mould the housing 50 within the handle portion 60. In order to minimise costs, the housing 50 can be manufactured as a low-cost die casting with an over-moulded plastics handle portion 60. In a high-quality example, the drive and driven gears 30, 31 may be made by MIM (metal injection moulding) or HPM (high pressure moulding). A metal moulded drive gear 30 may be attached to the inner housing profile 51 by rivets 36 formed with the gear to provide a low cost ratcheting mechanism 11 incorporating a wear resistant high torque drive gear 30.

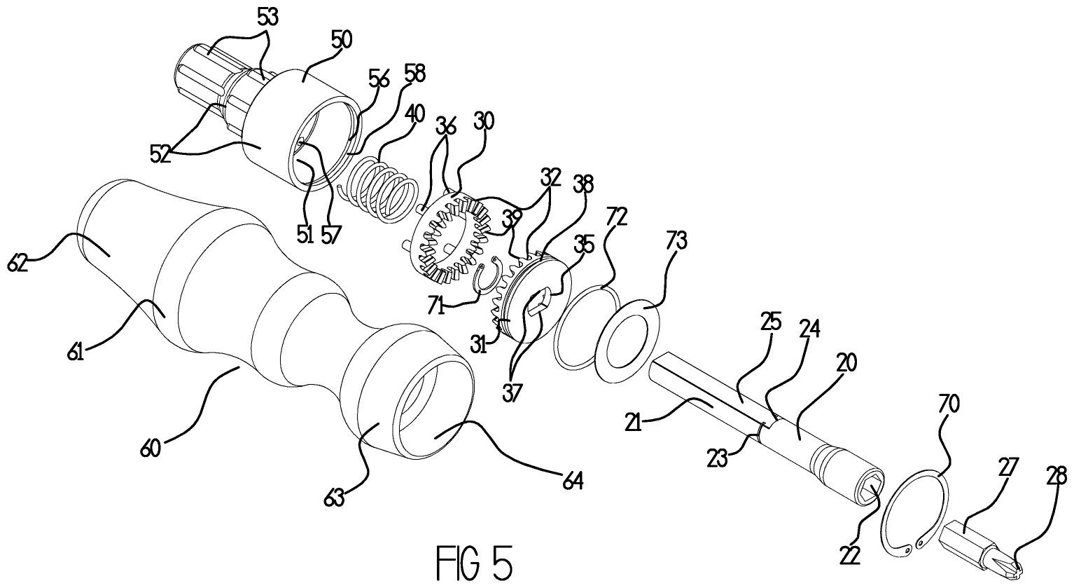

FIG. 4 shows the castellated teeth 32 of the drive and driven gear s 30, 31 with all of the teeth 32 able to engage at one time, thereby significantly increasing the level of drive torque DT that can be applied by the screwdriver 1, whilst minimising the amount of unwanted play during the engagement of the drive and driven gears 30, 31.

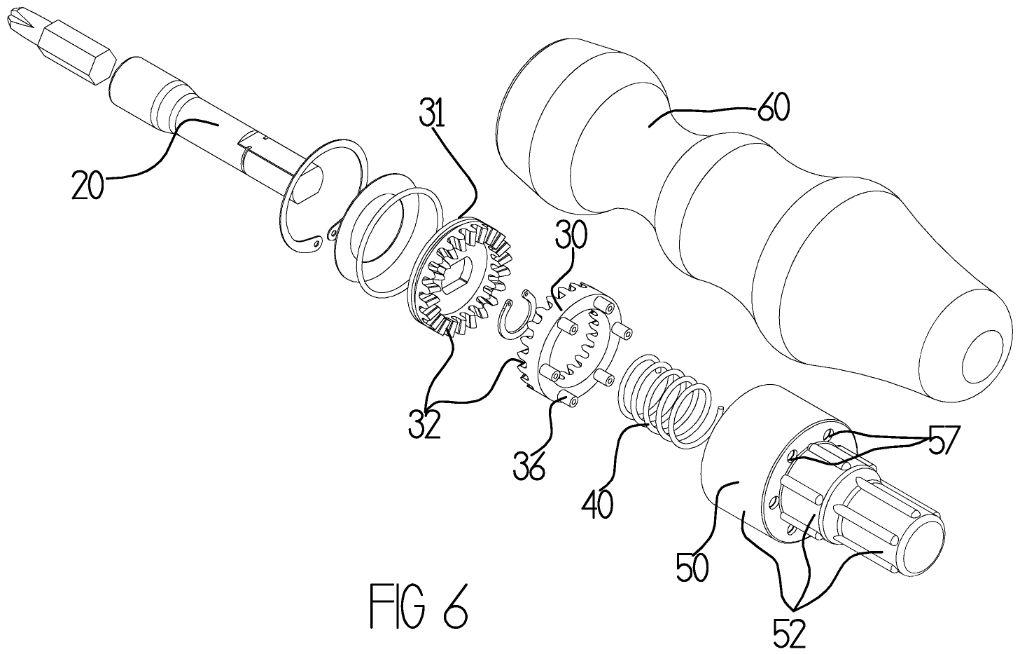

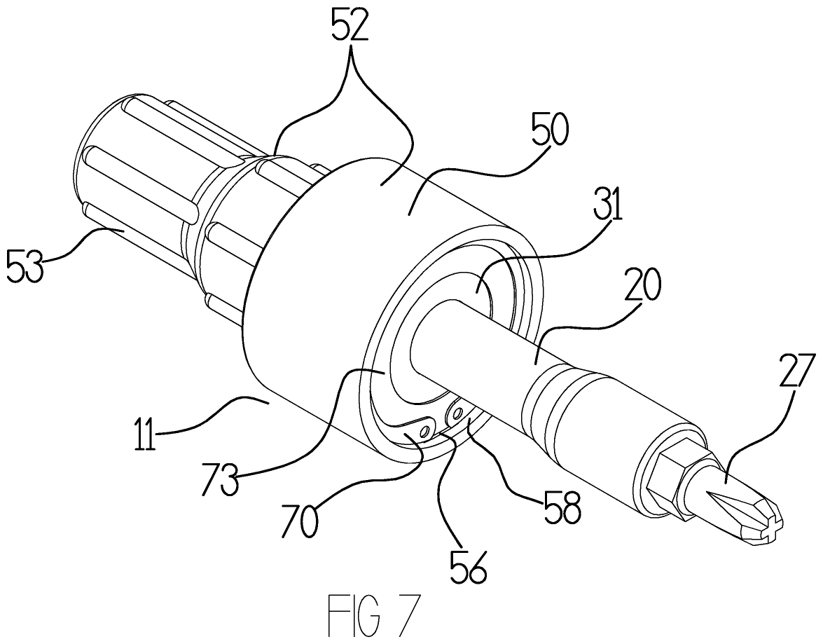

FIGS. 5 and 6 illustrate an example of a construction of the driven gear 31, wherein the driven gear has a centrally disposed shaft engagement aperture 35 that has at least two shaft engagement flats 37 configured mechanically engage a complementary driven gear retention portion 24 of the output shaft 20 that comprises engagement flats 25. One possible means for fixing the driven gear 31 to the output shaft 20 is an external circlip 71 that is engageable with a circlip groove 23 provided in the output shaft.

FIGS. 1, 3 and 4 illustrate the provision of a shaft axle bore, or chamber, 55 within the housing 50 for, preferably lubricated, close interaction with the inboard end 21 of the output shaft 20, which functions as a shaft axle, to provide a method of ensuring minimum flexing of the output shaft 20 with respect to the handle portion 60 and to further provide a low friction reverse or reposition action.

FIG. 2 shows the screwdriver 1 in use with an operator gripping a gripping profile 61 of the handle portion 60 and the screwdriver bit 26 engaging a recess 82 of a fastener head 81. In pushing the screwdriver bit 26 into the recess 82, the operator naturally pushes the handle portion 60 forward towards the fastener 80 to ensure positive engagement of the screwdriver bit 26 within the recess 82. The forward force FF applied, overcomes the gear separating biasing force provided by the resilient member 40 and drives the drive gear 30 into engagement with the driven gear 31. The meshing of the respective sets of teeth 32 locks the drive and driven gears 30, 31 allowing a drive torque DT applied by the operator in the chosen clockwise direction CD or anti-clockwise direction ACD to be transmitted to the output shaft 20 via the drive and driven gears 30, 31. When the operator wishes to reverse, or reposition, the handle portion 60, the forward force FF applied to the handle portion 60 is simply released, or relaxed, so that the drive and driven gears disengage under the influence of the resilient member 40 and the handle portion 60 can rotate relative to the output shaft 20. Since the drive and driven gears disengage, the fastener 80 does not have to engage the workpiece 90 sufficiently to provide a resistance to hold the output shaft 20 and allow the relative movement of the handle portion 60 in the way necessary with conventional screwdriver ratcheting mechanisms.

FIGS. 1, 5 and 7 illustrate a method of construction of the screwdriver 1 that enables the ratchet mechanism 11 to be serviced or repaired without specialist tools. The screwdriver shaft 20 and the attached driven gear 31 can be disengaged from the housing 50 by the removal of one internal circlip 70 from a circlip groove 56 provided within an internal lip 58 of the housing 50, although, any alternative sealed for life type closure could be employed.

Referring to FIGS. 5 and 7, the driven gear 31 may be provided with a seal groove 38 that extends around a peripheral surface of the driven gear. A housing seal 72 is seated in the seal groove 38 and acts between the driven gear 31 and the inner profile 51 of the housing 50 to prevent the ingress of detritus or moisture into the housing 50 so as to protect the ratchet mechanism 11.

The screwdriver 1 may have an output shaft 20 that has a free end, or tip, profiled to engage a particular type of fastener. Alternatively, as illustrated in FIGS. 1 to 7, the screwdriver 1 may have an output shaft 20 with a free end provided with a bit holder recess 22 configured to receive removable bits, such as the screwdriver bit 26, so that the screwdriver 1 can be used on a wide range of fasteners. In other examples, the free end of the output shaft 20 may be provided with a mechanism to releasably engage in the bore of a drive member in the manner of a socket wrench.

The handle portion and output shaft are aligned such that their respective longitudinal axes are coaxial or at least substantially parallel to one another.

It will be understood that the illustrated embodiments provide a bi-directional reversing torque driver or ratcheting screwdriver that has no switch in order to reverse the applied torque direction. A user simply has to apply the sufficient forward force to the handle to cause engagement of the drive and driven gears and then turn the handle in the direction necessary to apply the desired torque and when the handle is to be reversed or repositioned, relax the forward force to allow the gears to disengage so that the handle can rotate relative to the output shaft. Thus, switching the torque driver between torque applying and reversing, or handle repositioning, modes simply requires the application and relaxing of a forward force to the handle.

1. A bi-directional reversing torque driver comprising:
a handle having a lengthways extending axis defining an axial direction; and
a drive mechanism comprising a drive gear connected with the handle, a driven gear connected with an output shaft and a resilient member arranged to separate the drive and driven gears,
wherein said output shaft has a lengthways extending axis, an inner end and a free end that is spaced from said drive mechanism,
wherein said drive gear and driven gear are engageable by a user applied drive force that moves said handle in a said axial direction that is towards said free end of the output shaft so that a torque applied to said handle can be transmitted to said output shaft via said drive and driven gears, and
wherein said drive and driven gear are separated by said resilient member in the absence of said user applied drive force whereby a torque applied to said handle is not transmissible to said output shaft via said drive and driven gears so as to permit rotation of said handle relative to said output shaft.

2. A bi-directional reversing torque driver as claimed in claim 1, wherein said drive and driven gears comprise respective sets of teeth that project from respective opposed major faces of said drive and driven gears.

3. A bi-directional reversing torque driver as claimed in claim 2, wherein each said set of teeth comprises castellations disposed around the respective peripheries of said opposed major faces.

4. A bi-directional reversing torque driver as claimed as claimed in claim 2, wherein each tooth of said sets of teeth has oppositely facing flanks and said flanks are each disposed at the same angle to the respective said major face from which the tooth projects.

5. A bi-directional reversing torque driver as claimed claim 1, wherein said resilient member has a first end that engages said driven gear and a second end that acts against said handle.

6. A bi-directional reversing torque driver as claimed claim 5, wherein said resilient member extends through an aperture provided in said drive gear.

7. A bi-directional reversing torque driver as claimed claim 5, wherein said resilient member comprises a compression spring.

8. A bi-directional reversing torque driver as claimed in claim 1, wherein said drive mechanism is housed in a sealed chamber at least partially disposed within said handle.

9. A bi-directional reversing torque driver as claimed in claim 8, wherein said chamber is defined by a sealed housing secured to said handle.

10. A bi-directional reversing torque driver as claimed claim 9, wherein said handle is moulded onto said housing.

11. A method of operating a bi-directional reversing torque driver comprising a handle having a lengthways extending axis defining an axial direction; and
a drive mechanism comprising a drive gear connected with the handle, a driven gear connected with an output shaft and a resilient member arranged to separate the drive and driven gears,
wherein said output shaft has a lengthways extending axis, an inner end and a free end spaced that is spaced from said drive mechanism,
wherein said drive gear and driven gear are engageable by a user applied drive force that moves said handle in a said axial direction that is towards said free end of the output shaft so that a torque applied to said handle can be transmitted to said output shaft via said drive and driven gears, and
wherein said drive and driven gear are separated by said resilient member in the absence of said user applied drive force whereby a torque applied to said handle is not transmissible to said output shaft via said drive and driven gears so as to permit rotation of said handle relative to said output shaft,
said method comprising:
engaging a drive member disposed at said free end of said output shaft with a fastener;
applying said drive force to said handle to move said drive and driven gears into engagement;
applying said torque to said handle in a first direction, and
releasing said drive force to disengage said drive and driven gears and turning said handle in a second direction that is opposite said first direction to reposition said handle relative to said output portion.

12. A bi-directional reversing torque driver as claimed in claim 1, further comprising a screwdriver tip attached to said output shaft and wherein:
said handle has a proximal end and a distil end, the proximal end incorporates a housing that encapsulates said drive mechanism,
the drive gear comprises a first crown wheel and the driven gears comprises a second crown wheel,
the first crown wheel drive gear is attached to the handle and the second crown wheel is attached to the output shaft,
each said crown wheel has a periphery and gear teeth around said periphery,
wherein the arrangement is such that, in use a user automatically applies said user applied drive force when pushing against the handle to engage the screwdriver tip with a fastener head.

13. (canceled)

14. (canceled)

15. (canceled)

16. A bi-directional reversing torque driver as claimed in claim 12, wherein said gear teeth are castellated engagement teeth that each have upright flat engagement faces.

17. A bi-directional reversing torque driver as claimed in claim 16, wherein said castellated engagement teeth have peaked tips.

18. (canceled)

19. A bi-directional reversing torque driver as claimed in claim 12, wherein a shaft axle bore 55 is provided within the housing for lubricated close interaction with the inner end of the output shaft 20.

20. A bi-directional reversing torque driver as claimed in claim 12, wherein the output shaft 20 and said driven gear are secured to the housing 50 by one internal circlip that is received in a retention groove 56 within the housing and the driven gear is secured to the output shaft 20 by a retention circlip.

21. A bi-directional reversing torque driver as claimed in claim 12, wherein the drive gear is made of a first metal, the housing is a die casting made of a second metal that is softer than said first metal and the drive gear is attached to said housing.

22. A bi-directional reversing torque driver as claimed in claim 12, wherein the driven gear incorporates a seal groove 38 within said periphery, the housing has an inner profile and a housing seal is positioned between the driven gear and the housing inner profile to prevent the ingress of detritus and/or moisture into the housing.

23. (canceled)

24. A no-switch dual direction ratcheting screwdriver comprising bi-directional reversing torque driver comprising:
a handle having a lengthways extending axis defining an axial direction;
a drive mechanism comprising a drive gear connected with the handle, a driven gear connected with an output shaft and a resilient member arranged to separate the drive and driven gears; and
said output shaft having a lengthways extending axis, an inner end and a free end that is spaced from said drive mechanism,
wherein said drive gear and driven gear are engageable by a user applied drive force that moves said handle in a said axial direction that is towards said free end of the output shaft so that a torque applied to said handle can be transmitted to said output shaft via said drive and driven gears, and
wherein said drive and driven gear are separated by said resilient member in the absence of said user applied drive force whereby a torque applied to said handle is not transmissible to said output shaft via said drive and driven gears so as to permit rotation of said handle relative to said output shaft.
